(19) United States
(12) Patent Application Publication
(10) Pub. No.: US 2026/0178723 A1
(43) Pub. Date: Jun. 25, 2026

(54) DEVICE VERIFICATION USING A DEEP-LEARNING-BASED KEY-LOCKER FRAMEWORK

(71) Applicant: PAYPAL, INC., San Jose, CA (US)

(72) Inventors: Zhe Chen, Singapore (SG); Panpan Qi, Singapore (SG); Fei Pei, San Jose, CA (US); Mandar Ganaba Gaonkar, Fremont, CA (US); Wai Yin Cheung, Sunnyvale, CA (US); Yuxing Zheng, San Jose, CA (US); Quan Jin Ferdinand Tang, Singapore (SG); Gaurav Vishwanath Rane, Fremont, CA (US)

(21) Appl. No.: 18/999,911

(22) Filed: Dec. 23, 2024

(51) Int. Cl. G06F 21/44; G06F 21/64

(52) U.S. Cl. CPC G06F 21/44; G06F 21/64

(57) ABSTRACT

A method includes partitioning a set of historical device keys into a set of clusters, embedding the set of clusters to generate a set of device lockers, and receiving a request including an application identifier and metadata. The application identifier corresponds to an application installed on the second computing system and the metadata corresponds to the second computing system. The method also includes combining the application identifier and the metadata to generate a device key, determining that the set of device lockers includes a device locker that matches the device key, and, in response to determining that the set of device lockers includes the device locker that matches the device key, adding the device key to a cluster of the set of clusters corresponding to the device locker.

### TECHNICAL FIELD

The present disclosure relates to electronic device verification and, more particularly, to a deep-leaning-based key-locker framework for privacy-enhanced device verification.

### BACKGROUND

Privacy regulations and operating system controls restrict access to unique device identifiers and other metadata, which are often used for accurately identifying and verifying user devices. This limitation makes it difficult to reliably distinguish between legitimate users and potential fraud when only limited data is available, particularly in browser-based interactions where app-specific information is inaccessible.

### BRIEF DESCRIPTION OF THE DRAWINGS

Certain features of the subject technology are set forth in the appended claims. However, for the purpose of explanation, several embodiments of the subject technology are set forth in the following figures, where like reference numerals refer to the same or similar features in the various figures.

FIG. 1 is a block diagram of an example deep-learning-based key-locker system framework for device verification, in accordance with one or more embodiments.

FIG. 2 is a flow chart of an example process for locker initialization, in accordance with one or more embodiments.

FIG. 3 is a flow chart of an example process for device verification based on the key-locker framework, in accordance with one or more embodiments.

FIG. 4 is a sequence diagram of an example process for application identifier storage, in accordance with one or more embodiments.

FIG. 5 is a sequence diagram of an example process for application identifier retrieval, in accordance with one or more embodiments.

FIG. 6 is a block diagram of an example process for key-locker matching by sequence labeling, in accordance with one or more embodiments.

FIG. 7 is a block diagram of an example computing system, in accordance with one or more embodiments.

### DETAILED DESCRIPTION

In an era of stringent privacy regulations and system controls, such as those imposed by mobile device operating systems, the ability to accurately identify user devices is increasingly constrained, yet it remains useful for maintaining online security. The ability to accurately identify user devices may often be used for a range of applications, including user verification, fraud detection, device continuity, and mapping user behavior across devices. When users access applications and platforms through a web browser, however, these privacy constraints may limit access to app-specific identifiers and other unique device data, which may be used for device recognition and verification. As a result, the absence of robust device identification tools in the browser environment creates a gap in ability to reliably confirm device identity, thereby weakening safeguards against unauthorized access, fraud, and account misuse.

The present disclosure provides deep-learning-based key-locker verification techniques that enhance device verification while minimizing data usage from user devices. The disclosed key-locker verification techniques use minimal device information to create one or more device profiles (also referred to herein as “device lockers”) for each user. When a user accesses a platform (e.g., website, web application, etc.), one or more deep learning models (e.g., recurrent neural networks, long short-term memory networks, convolutional neural networks, etc.) may generate a device key. The device key may be generated based on an application identifier and behavioral information from an electronic device. A sequence labeling approach may then be used to efficiently match the generated device key with existing device lockers. If a match is found, the user may be allowed to interact with (e.g., access) the platform and a dynamic updating process may be used to automatically update the existing device lockers, reflecting the most recent device locker used by the user. If a match is not found, the user may not be allowed to interact with the platform and the system may indicate to the platform that further action should be taken to secure the platform.

Artificial Intelligence (AI)-based device verification techniques, as described herein, offer technical advantages in securely and accurately identifying user devices while adapting to privacy and regulatory constraints. Traditional methods rely on static identifiers, which are increasingly restricted by privacy regulations and mobile operating system controls. In contrast, AI-based techniques can leverage behavioral patterns, temporal data, and non-intrusive metadata to construct dynamic, context-aware profiles. This adaptability allows for precise device recognition without relying on sensitive, persistent identifiers, making the device verification more resilient to evolving user device changes.

Another technical advantage of AI-based device verification is its ability to learn and adapt to user behaviors over time. A device locker system, for instance, may create a chronological sequence of lockers that represent device interaction patterns, updating dynamically as new data is received. By incorporating temporal aspects through techniques such as time-decay functions and sequential labeling, the device verification may prioritize recent behaviors and adjust lockers accordingly. This adaptation may provide a more accurate and current representation of a user's device usage, which may enhance the ability of the device verification to detect anomalies, recognize legitimate users, and flag suspicious activities. Such continuous adaptation may also help maintain performance even when a user's device or interaction patterns evolve over time, minimizing false positives and improving the user experience.

Furthermore, the device verification techniques may benefit from the computational efficiency of clustering and projection techniques, which allow it to condense device profiles into cohesive representations, or clusters. By organizing similar device profiles into clusters, the device verification techniques reduce the volume of data required to process each verification request, significantly enhancing response times and scalability. In scenarios where millions of devices might be interacting with a platform, clustering provides a way to handle vast amounts of data efficiently. Moreover, by leveraging deep learning models, such as bidirectional encoder representations from transformers (BERT) and bidirectional long short-term memory (BiLSTM) networks, in conjunction with probabilistic modeling (e.g., hidden Markov models (HMM)), the device verification techniques may capture nuanced patterns and dependencies across lockers, resulting in robust device recognition that is both scalable and responsive.

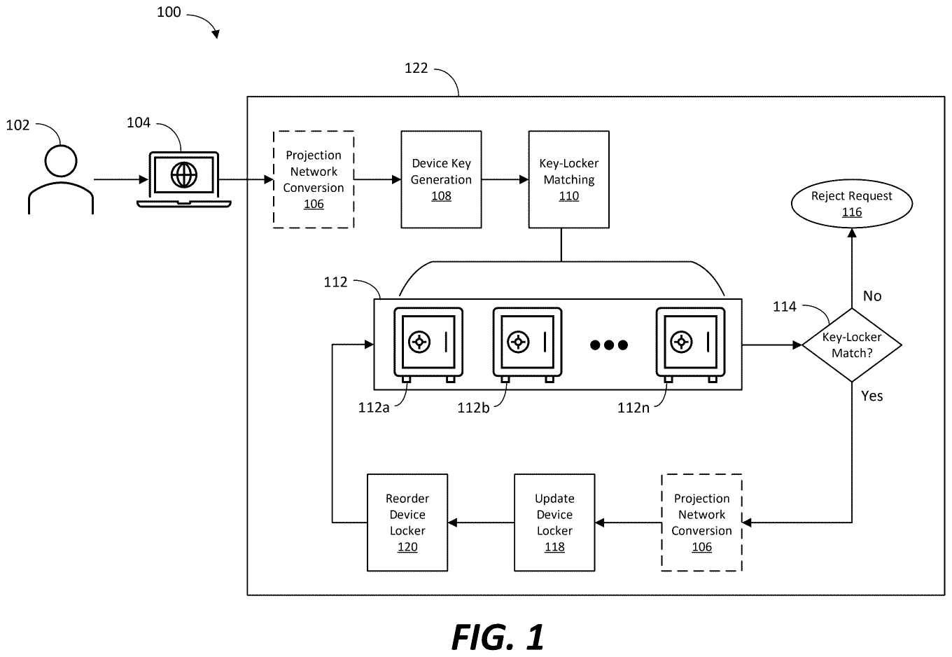

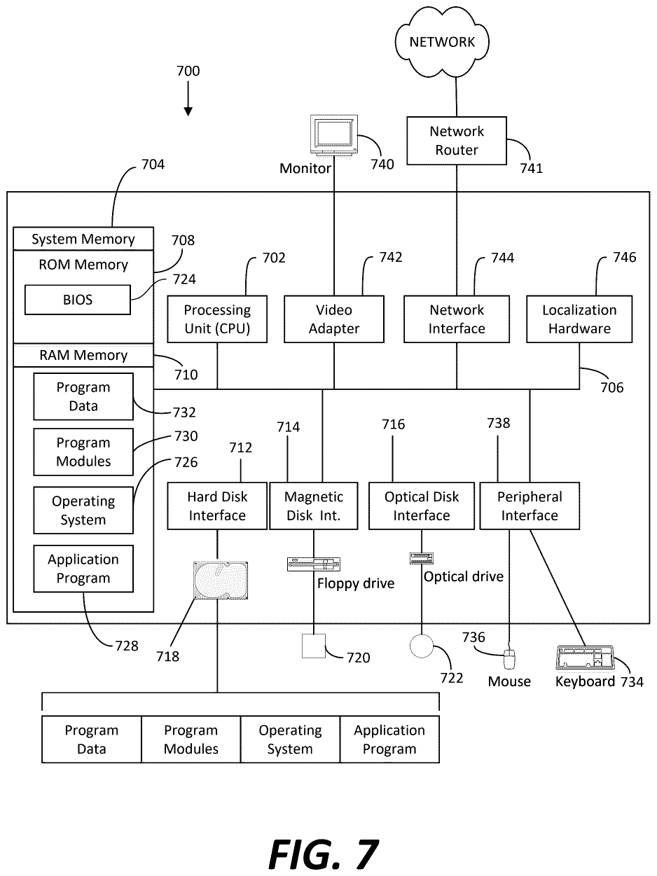

Referring now to the drawings, wherein like numerals refer to the same or similar features in the various figures, FIG. 1 is a block diagram of an example deep-learning-based key-locker system 100 for device verification. Not all of the depicted components may be used in all embodiments, and one or more embodiments may include additional, fewer, or different components than those shown in the figure. Variations in the arrangement and type of components may be made without departing from the spirit or scope of the claims as set forth herein. Furthermore, the modules described with respect to the system 100 are used for convenience to refer to functionality that the system 100 is configured to perform by way of one or more components of the system 100 (e.g., computer-readable instructions in memory), which is described in detail below with respect to FIG. 7.

The system 100 may include a user device 104 associated with a user 102. The user device 104 may be a computing device such as a laptop computer, desktop computer, tablet, smartphone, smartwatch, or any other electronic device, such as described with respect to FIG. 7. The user device 104 may be in network communication with a server 122. The user device 104 may include one or more software applications, which may be used to access platforms, such as web applications, websites, API endpoints, and/or the like. The user device 104 may also include a web browser, which may be used to access platforms over the internet protocols (e.g., hypertext transfer protocol (HTTP)). The user device 104 may be configured to store an identifier of an included software application as a browser cookie that can subsequently be used by the web browser to access the application identifier. The user device 104 may also be configured to generate one or more representations of device and/or behavioral metadata. For example, the user device 104 may be configured to generate one or more key embeddings corresponding to data relating to the user device 104 (e.g., make and model) and/or user behavior (e.g., whether inputs were performed by a user 102 or browser-executed scripts).

The server 122 may be an electronic device such as described with respect to FIG. 7. The server 122 may host (or may be in network communication with another server that hosts) a platform such as a web application, web site, API endpoints, and/or the like. The server 122 may host a device verification system that helps prevent unauthorized access to the platform, detect potential fraud, and secure user accounts without relying solely on user credentials.

The server 122 may include a projection network conversion module 106. The module 106 may be embodied as hardware and/or software on the server 122 that converts key embeddings (e.g., from the user device 104) into an embedding space used by device lockers 112. The conversion may enable direct comparison (e.g., alignment) between different types of data (e.g., data output into different forms by different models) by virtue of the different types of data being represented by respective embeddings vectors in the common embedding space. The module 106 may include a projection network, which may be or may include a neural network designed to map inputs into a shared (e.g., compatible) representation space.

The projection network, which may include one or more fully connected layers (e.g., a deep neural network), may be trained to map an input embedding onto a common representation space by generating an output embedding that is a transformed version of the input embedding compatible with the common representation space. The transformation may be achieved by training the projection network to project input embeddings in such a way that related inputs (e.g., device keys from the same device) appear closer together (e.g., with a similarity measure such as cosine similarity) in the shared space, while unrelated inputs (e.g., device keys from different devices) remain farther apart. The training process may be unsupervised, enabling flexibility and adaptability across diverse datasets. In some embodiments, the training may be contrastive learning, which may maximize the similarity between positive pairs (e.g., a device key and another device key from the same device) and minimize the similarity between negative pairs (e.g., a device key and a device key from a different device). Once projected into the shared space, similarity calculations may be simpler and more efficient, as they can utilize straightforward distance metrics rather than complex, domain-specific comparisons. Additionally, since the projection network may learn to emphasize the most relevant features during conversion, the projection model may generalize better to new data, making it more adaptable across varied device types or user behaviors.

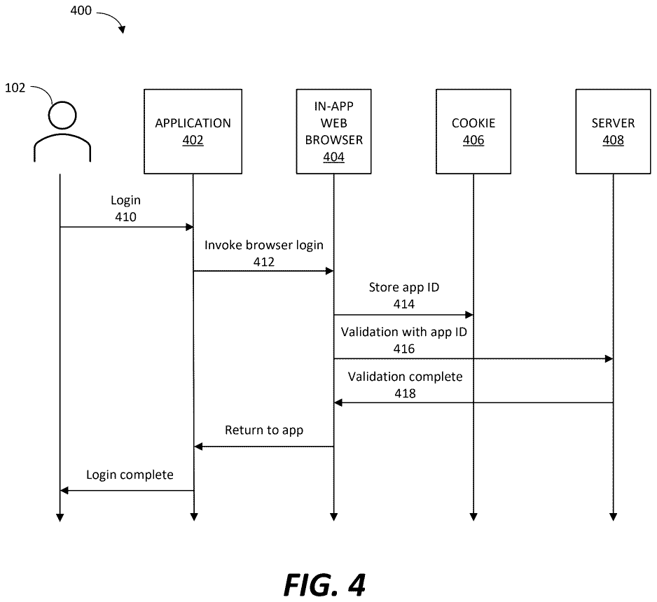

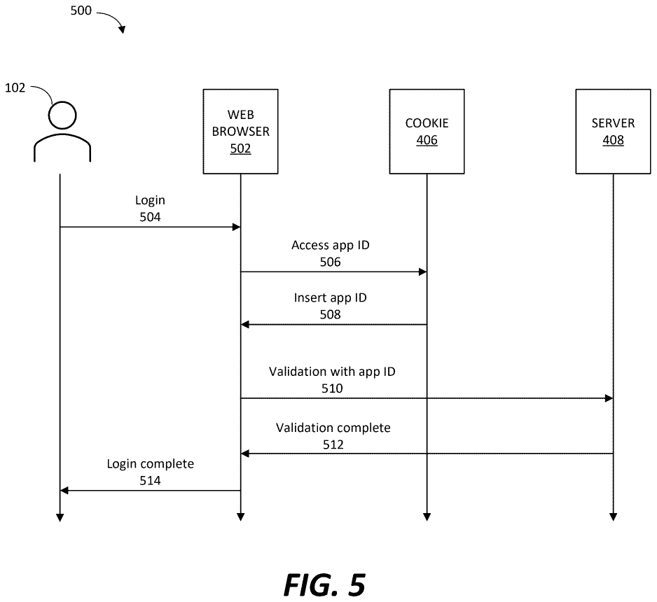

The server 122 may include a device key generation module 108. The module 108 may be embodied as hardware and/or software on the server 122 that generates a device key for the device 104. The device key may include two components: an application identifier and a key embedding. The application identifier may represent a unique identifier that can be used to differentiate a device on which an application is installed. For example, an application installed on a first device may generate a different application identifier than the application installed on a second device. The key embedding may represent behavioral data, such as metadata of the user device 104 (e.g., device model, processor core count, amount of memory) and/or interaction data (e.g., method of cursor movement and text input). An embedded version of the application identifier may be combined (e.g., concatenated) with the key embedding to generate the device key. The device key may be associated with incoming traffic from the user device 104 (e.g., for a particular session). In some embodiments, other information may be combined with the embedded application identifier and key embedding, such as an internet protocol (IP) address of the user device 104. The process for storing and retrieving an application identifier is described in more detail below with respect to FIGS. 4-5.

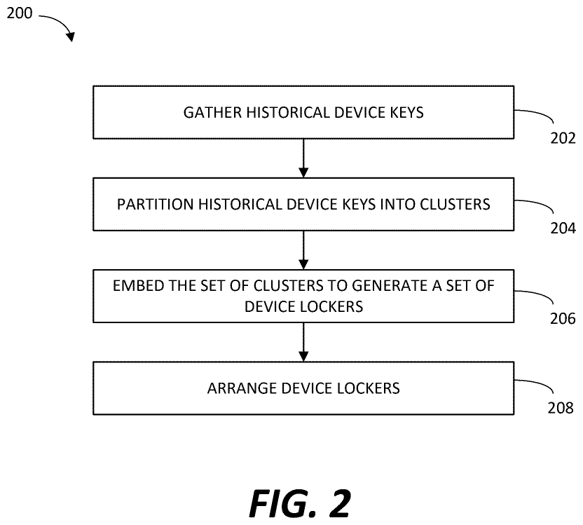

The server 122 may include a key-locker matching module 110. The module 110 may be embodied as hardware and/or software on the server 122 that matches a device key (e.g., generated by module 108) to a device locker. The server 122 may store one or more device lockers 112 (e.g., device locker 112a, 112b, . . . , 112n). The device lockers 112 may be associated with the user 102 and may represent a snapshot of the device metadata, behavioral data, and/or other identifying features from past interactions by the user 102. Each locker 112 may be a representation of a cluster of previous device keys, such as the cluster centroid. Each locker 112 may be organized chronologically, forming a timeline of how the user's interactions with the platform have evolved over time. The initialization of the lockers 112 is described below with respect to FIG. 2.

When a new device key is generated in response to a user interaction, the module 110 may attempt to match it against the lockers 112 to verify the identity of the device 104. By comparing the current key to historical lockers, the module 110 can assess if the behavior and characteristics of the device 104 are consistent with the user's profile, which helps verify that only legitimate devices gain access to the platform. The matching process may involve machine learning models (e.g., neural networks or attention mechanisms) trained to compare the device key and lockers and produce match outputs (e.g., scores or labels) that indicate whether a particular locker aligns with the device key.

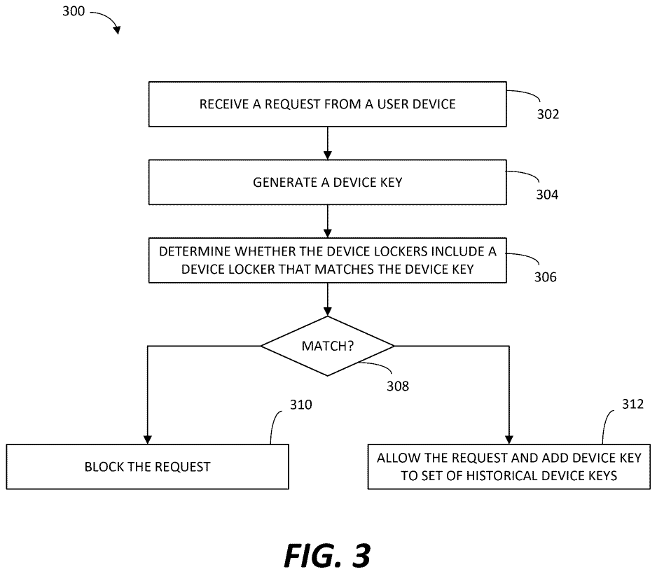

The key-locker matching process may utilize sequence modeling techniques, including models such as a BiLSTM network combined with an HMM, to model the sequence of lockers and their relationship with the device key. The HMM may predict the most likely sequence of “match” or “not match” labels, identifying the locker that corresponds most to the device key while capturing transitions and dependencies across time. In some embodiments, the matching process may also consider temporal aspects of user behavior. To do so, the matching process may incorporate a time-decay function when initializing the lockers 112 to emphasize recent behaviors more heavily than older behaviors. The prioritization allows the module 110 to reflect current user behaviors and patterns more accurately. The matching of a device key to a locker 112 is described in more detail below with respect to FIG. 3.

With the sequence of labels, at operation 114, the module 110 may direct the server 122 as to the appropriate handling of the network traffic (e.g., requests) of the device 104. If the sequence of labels output by the module 110 does not include a “match” label, then the module 110 may direct the server 122 to reject (116) the network traffic of the device 104, as the device 104 could not be verified. In some embodiments, the module 110 may issue an alert (e.g., an error message) and/or cause the server 122 to request other forms of verification from the device 104 (e.g., two-factor authentication, a challenge-response test, etc.). If the sequence of labels includes a “match” label, then the module 110 may direct the server 122 to accept the network traffic of the device 104. For example, the module 110 may direct the server 122 to process the network traffic and allow the user 102 access to the platform. The module 110 may also provide the device key to a device locker update module 118 to update the set of lockers 112 for subsequent verifications. In some embodiments, if the device has not already been transformed to be in the same embedding space as the set of lockers 112, the module 110 may also provide the device key to the module 106 to transform the device key to be in the same embedding space as the set of lockers 112 to streamline the incorporation of the device key into the set of lockers 112. Otherwise, the module 110 may provide the transformed device key from the module 106 to a device locker update module 118 to streamline the incorporation of the device key into the set of lockers 112. In some embodiments, the server 122 may not include the module 106 and/or may not transform the device key before or after key-locker matching.

The server 122 may include a device locker update module 118. The module 118 may be a hardware and/or software module on the server 122 that dynamically updates the device lockers 112 by incorporating the device key into the set of lockers 112. As the user device 104 information may evolve and the user behavior may change over time, the sequence of lockers 112 may be updated based on the validated user profile, which may be represented by the device key with the “match” prediction from the sequence labeling process of module 110. In some embodiments, the lockers may be updated based on an unmatched but verified device key, where the device key does not have a “match” label but the user 102 passes some other identity verification process (e.g., two-factor authentication, CAPTCHA, etc.). The module 110 may determine the pair-wise similarities between the device key and the lockers 112. In some embodiments, the pair-wise similarities may be between the transformed feature vector from module 106 and the lockers 112. Then, for the locker 112a that is most similar to the device key (or transformed feature vector) (e.g., has a similarity score that exceeds a predetermined threshold level of similarity), the device key (or transformed feature vector) may be added into the cluster associated with the locker 112a (e.g., the cluster of previous device keys) and the cluster centroid (which the locker 112a may represent) may be updated accordingly. In some embodiments, if the device key (or transformed feature vector) is less than or equal to the predetermined threshold level of similarity (e.g., when the device key is unmatched but verified), the corresponding device keys of each locker 112a-112n of the set of lockers 112 and the device key (or transformed feature vector) may be used for contrastive projection network retraining (e.g., to retrain the network of module 106) and/or re-clustering of the previous device keys to generate new device lockers 112. The result may then be an updated and/or refreshed set of lockers 112. Incorporation of the device key into the set of lockers 112 is described in more detail below with respect to FIG. 3.

The server 122 may include a device locker reordering module 120. The module 120 may be a hardware and/or software module on the server 122 that orders the lockers 112 chronologically for key-locker matching. The lockers 112 may each be associated with a timestamp of their most recent device key. The lockers 112 may then be sorted based on their respective timestamps so that the locker sequence is in chronological order of their updated times.

In operation, when a user 102 attempts to log in to a platform (e.g., via a web browser on the device 104 rather than a platform application on the device 104), the server 122 may generate a device key corresponding to the current verification (e.g., login) attempt corresponding to the device 104. The device key may be provided as input with a set of lockers 112 into the module 110, which generates a sequence of labels corresponding to the set of lockers 112. The sequence of labels may indicate whether the current verification attempt (represented by the device key) is consistent with past verification attempts by the user 102 (represented by the sequence of labels). If the current verification attempt is consistent with the past verification attempts, the verification attempt is more likely to be legitimate, and the server 122 may approve the login. Conversely, if the current attempt is significantly different from the past attempts, the verification attempt is more likely to be a security threat, such as an unauthorized login, and the server 122 may reject the login or cause additional verification operations to be performed.

FIG. 2 is a flow chart of an example process 200 for locker initialization. For explanatory purposes, FIG. 2 is described herein with reference to the system 100 of FIG. 1, and thus the process 200 may be computer-implemented. However, this is merely illustrative, and features of the system 100 may be performed by any other system for implementing the subject technology. Additionally, for explanatory purposes, the operations of the process 200 are described herein as occurring sequentially or linearly. However, multiple operations of the process 200 may occur in parallel. The operations of the process 200 need not be performed in the order shown, and one or more operations of the process 200 need not be performed or can be replaced by other operations.

At operation 202, the process 200 may include gathering (e.g., obtaining, accessing, retrieving) a set of historical device keys representing previous user interactions with the server 122 (e.g., interactions specific to user 102). Each historical device key may be a vectorized representation that encodes an application identifier (if available, otherwise blank identifier such as a set of zeroes), metadata (e.g., device model, operating system version) and/or behavioral data (e.g., frequency of app use, login time, login method) respective of the user interactions. The set of historical device keys may be gathered from memory of the server 122, and the set of historical device keys may have been developed over the course of various user interactions (e.g., login attempts) with the server 122.

In some embodiments, recent behaviors may be weighted to have a stronger influence on a subsequent clustering process. To do so, the server 122 may apply a time-decay function to each device key to prioritize the device keys based on their respective age. For example, each historical device key may be weighted by an exponential time decay parameter α=e^{-βt}, where t is the time (e.g., number of days old) and β controls the rate of decay.

In some embodiments, the server 122 may perform the process 200 with respect to a plurality of users, separately or in parallel with the user 102, and thus the server 122 stores device keys and lockers for multiple users.

At operation 204, the server 122 may partition historical device keys into a set of clusters to group similar device profiles of the user and behavioral patterns of the user. The partitioning (e.g., clustering) approach may involve aggregating historical device keys, each representing a snapshot of a device's (e.g., device 104) metadata, recent user behavior, and temporal data. By clustering the historical device keys, the server 122 can capture and summarize common characteristics across similar devices, creating a cohesive representation of user behavior over time.

In some embodiments, operation 204 may include clustering the set of historical device keys with a modified K-Means clustering algorithm tailored to account for the temporal significance of the device keys. The modified K-Means clustering algorithm may integrate time-decayed weights into the clustering process, causing cluster centroids to be biased toward more recent behaviors. Over time, newer device keys may influence the time-weighted clusters causing the time-weighted clusters to adjust to developments in user behavior.

In some embodiments, the server 122 may generate the clusters (e.g., partition the historical device keys) before or during a verification process. If handled before verification, the server 122 may periodically process the historical device keys and generate clusters (e.g., offline), creating device lockers that are ready to use during a verification process. This approach may be suitable for high-traffic systems, as computationally expensive clustering tasks are handled separately from the real-time verification process. Pre-generated clusters also enable the use of the same lockers for multiple verification requests, which can improve stability and reproducibility of the verification process. If handled during verification, the server 122 may dynamically generate and/or update lockers on-the-fly based on the device key. Real-time clustering may help the lockers reflect the most current user behaviors and device metadata, improving accuracy for new or changing devices.

At operation 206, once historical device keys are partitioned into clusters (e.g., based on similarity in metadata and behavioral patterns), the server 122 may embed each cluster to generate a device locker (e.g., lockers 112). The result may be a vectorized representation of each cluster's center (also referred to as the centroid), combining representations of device attributes and behavioral insights into a single, multi-dimensional embedding that reflects the general behavior profile of that cluster.

At operation 208, the server 122 may arrange the device lockers in a sequence to be input, along with a device key, into a set of models designed for sequence labeling (also referred to as the “sequence labeling models” or collectively as the “sequence labeler”). Operation 208 may include arranging the device lockers in chronological order based on their most recent update timestamps (e.g., most recently incorporated device key).

As a result of chronological ordering, the sequence labeling models may evidence the progression of device and user behavior over time, enabling determination of historical trends in device and user behavior. By arranging the lockers chronologically, recent behaviors may be given context within the broader history of the user's interactions, enhancing the ability of the sequence labeling models to interpret device changes accurately.

Furthermore, as a result of embedding the cluster centers into lockers, the verification process may be simplified, as verification involves evaluating the new device key against a reduced set of comprehensive profiles.

The lockers may be updated periodically as new device keys are added, refining each locker's representation (e.g., centroid embedding) to reflect evolving user behaviors and device changes. This adaptability helps lockers stay relevant to current usage patterns while retaining long-term behavioral insights. The process of embedding clusters into lockers enables scalability, as new device keys can be incorporated into existing lockers without requiring complete reprocessing, maintaining system efficiency over time. For example, the new device key may be incorporated into the cluster associated with a matching locker, and the centroid for that cluster may be updated accordingly.

FIG. 3 is a flow chart of an example process 300 for device verification based on a key-locker system. For explanatory purposes, FIG. 3 is described herein with reference to the system 100 of FIG. 1, and thus the process 300 may be computer-implemented. However, this is merely illustrative, and features of the system 100 may be performed by any other system for implementing the subject technology. Not all of the depicted components may be used in all embodiments, and one or more embodiments may include additional, fewer, or different components than those shown in the figure. Variations in the arrangement and type of components may be made without departing from the spirit or scope of the claims as set forth herein.

At operation 302, the server 122 may receive a request to access a platform (or other web traffic) from a user device (e.g., device 104). Once a request is received from the user device, the server 122 may trigger a verification process, which may involve authenticating the user device by comparing its current state with previously recorded data (e.g., associated with the device and/or the user's account on the server 122).

The request may include metadata about the device 104, such as non-intrusive data permitted under privacy regulations. Metadata about the device 104 may include device type (e.g., make and model), operating system type (e.g., brand and version), browser type (e.g., browser engine), network characteristics (e.g., cellular or Wi-Fi network type and IP address), and/or other data.

The request may also include user behavior data that reflects the interactions of the user with the server 122 and/or the user device 104. Behavior data may include data relating to the interactions of the current verification attempt, such as how the user attempted to log in (e.g., via a log in page on a web browser), how the user provided input (e.g., via touchscreen), where the request originated (e.g., a location corresponding to an IP address), what device was used, and/or the like. In some embodiments, user behavior data may include data from a set of verification attempts, such as frequency of platform interactions (e.g., logins per day or week), average session duration (e.g., how long the user typically remains active), common usage patterns (e.g., preferred actions within the platform or common times of day for activity), and/or the like.

The request may also include the application identifier. The application identifier may be a unique identifier generated by an application installed on the user device 104 that can be used to differentiate user devices. The application identifier may be generated and stored (e.g., in a browser cookie) on the user device 104 by an application installed on the user device 104.

The behavioral data (e.g., device metadata and user behavior) and/or application identifier of the request may be in a vector (e.g., embedded) representation. The vector representation may encode the data in a structured, machine-readable format, enabling secure transmission of the data and enabling downstream models to process the data for analysis. The vectorization may include preprocessing steps (e.g., normalization) to standardize the data so that the data can be consistently compared with other vectors.

Before generating the device key, the server 122 may identify the user account associated with the request, which allows the server 122 to retrieve the sequence of lockers associated with that user's past interactions with the server 122. To do so, the request may include a user identifier (e.g., credential, application identifier tied to the user device 104, etc.) that the server 122 may use to identify the user account.

At operation 304, the server 122 may generate a device key (e.g., with module 106). The device key may be a representation of the current state of the device 104, combining its behavioral data (e.g., device metadata and recent user behavior) and application identifier stored on the device 104 (e.g., by an application installed on the device and associated with the platform).

Generating the device key may include combining the representation (e.g., vector embedding) of the application identifier with the representation (e.g., vector embedding) of the behavioral data (also referred to as the “key embedding”) to form a device key. For example, the combination may be a simple concatenation of the two representations. Once fully generated, the device key may be temporarily stored as the active representation of the device 104 for the current verification session.

In some embodiments, if the application identifier and/or behavior data were not included in the request as vector representations, the operation 304 may further include transforming the application identifier and/or behavior data into vector representations. For example, the server 122 may use a FastText algorithm to convert the application identifier into a vector embedding. If the application identifier is missing or cannot be found, a blank identifier (e.g., a set of zeros) may be used to represent the missing value, which may then be converted into a vector embedding using the same FastText algorithm.

In some embodiments, generating the device key may also include transforming the device key to be more compatible with the representation space shared with the set of device lockers. The server 122 may use a projection network to transform the application identifier and/or behavior data of the device key, enabling more efficient comparison with the set of device lockers.

At operation 306, the server 122 may determine whether the set of device lockers 112 includes a device locker that matches the device key. Determining whether the set of device lockers includes the device locker that matches the device key may include using one or more machine learning models to generate a sequence of labels based at least in part on the device key and a set of transition probabilities between each device locker. Each label of the sequence of labels may indicate whether a corresponding device locker matches the device key. The server 122 may have arranged (at operation 208) the set of device lockers 112 chronologically (or may do so as a part of operation 306) to prepare them as input to the sequence labeling models. As a result of chronological ordering, the sequence labeling models may evidence the progression of device and user behavior over time, enabling determination of historical trends in device and user behavior.

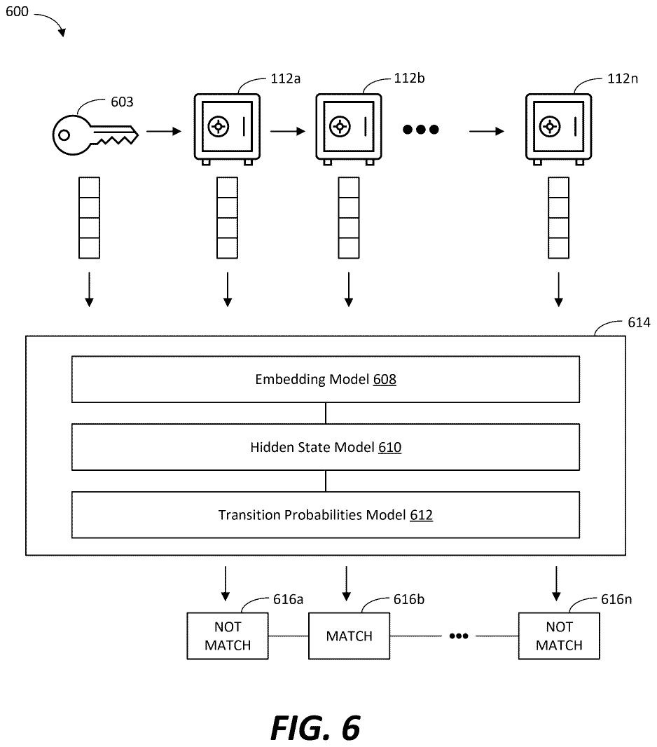

The server 122 may use a set of sequence labeling models to analyze the device key against each locker in the set of lockers 112. The set of models (e.g., BERT, BiLSTM, and HMM) may compare each locker to the device key and assign a label based on the comparison. The label may be binary (e.g., “match” or “not match”) or a probability (e.g., a percent likelihood of a match, where a match may be a probability above a predetermined threshold). The set of models is described further below with respect to FIG. 6.

At operation 308, with the generated label sequence, the server 122 may select a device locker 112 that corresponds to a “match” label of the sequence of labels. If there is not a match, the process 300 may proceed to operation 310. If there is a match, the process may proceed to operation 312.

At operation 310, when the server 122 does not find a match between the current device key and any of the historical device lockers 112 (e.g., if the device cannot be verified), the device 104 likely does not align with any of the user's established profiles (e.g., lockers 112). This could mean the device 104 is new, that there have been significant changes in the user's behavior or device metadata, or that the access attempt might be unauthorized. At operation 310, the server 122 may take specific actions to handle the unverified device, balancing security and user experience. For example, the server 122 may reject the request (116).

Handling the unverified device may include flagging the device 104 for additional verification steps to verify that the access attempt is legitimate. Depending on the security protocols in place, such additional verification steps may include a multifactor authentication request (e.g., prompting the user to verify their identity through a secondary method, such as entering a code sent to their registered phone number or email address). If the user successfully completes the additional verification, the server 122 may treat the unverified device as a new device and create a new locker for the device key. Creating a new locker may enable the server 122 to track the device 104 in the future, gradually building a profile to facilitate verification in subsequent sessions. The new locker may become part of the user's history (e.g., set of lockers 112), contributing to a more comprehensive representation of their devices.

Handling the unverified device may include flagging the device 104 as potentially anomalous and placing it under heightened monitoring. For example, the server 122 may track the behavior of the device 104 over time, looking for any suspicious activity patterns (e.g., frequent location changes, high-frequency logins, or erratic usage). If the device 104 continues to exhibit unusual behavior or fails to align with other historical lockers in future interactions, the server 122 may take further action, such as temporarily blocking access or notifying the user of potentially unauthorized activity.

In some embodiments, to maintain transparency and ensure the user 102 is aware of any security concerns, at operation 310, the server 122 may send a notification about the unverified access attempt. The notification may be an email, text message, and/or in-app notification informing the user that a new or unfamiliar device attempted to access their account. Notifications may help keep the user 102 informed and give the user 102 an opportunity to confirm or report the access attempt. If the user 102 recognizes the device, the user 102 may mark it as safe, which may allow the server 122 to proceed with creating a new locker for future verification.

In some embodiments, if the server 122 often fails to recognize legitimate user devices (e.g., a failure rate surpasses a threshold failure rate), the server 122 may retrain one or more of the sequence labeling models described above. The server 122 may calculate a failure rate based on a number of unverified device keys over a period of time compared to a number of successfully completed additional verifications over the same period of time. If the failure rate meets or exceeds a predetermined threshold failure rate, the server 122 may retrain one or more of the sequence labeling models and/or regenerate the set of device lockers with the sequence labeling models. Feedback from unverified attempts (e.g., additional verification) may also help refine the thresholds (e.g., of the HMM) for “match” and “not match” decisions (e.g., probability thresholds), enhancing the ability of the server 122 to distinguish between legitimate behavioral shifts and truly anomalous activities.

At operation 312, if the server 122 finds a match between the current device key and any of the historical device lockers 112 (e.g., if the device can be verified), the server 122 may conclude that the device 104 in use is consistent with the user's established profile (e.g., set of lockers 112), suggesting the device 104 is a recognized and legitimate device. The server 122 may allow the request (e.g., route the request to its intended destination) and then take actions to maintain continuity in the profile of the user 102 (e.g., update the matching locker with the latest information).

Upon identifying a match, at operation 312, the server 122 may update a locker (e.g., the matching locker) with the device key. Updating may help the locker reflect the current state of the device 104, including any changes in metadata (e.g., OS version updates) or shifts in behavior (e.g., increased usage frequency). By updating, the module 118 may maintain an accurate profile (e.g., set of lockers 112) for future verification, allowing the server 122 to recognize the device 104 even if subtle changes occur over time.

Updating a locker may include transforming the device key into a vector embedding in the same embedding space as the lockers (e.g., via the contrastive projection network of module 106) and/or identifying the most similar locker to the device key (e.g., in the case of multiple matching lockers). The device key may be added to the cluster of historical device keys associated with the most similar locker, and the center of that cluster may be updated accordingly (e.g., recalculated).

In some embodiments, identifying the most similar locker to the device key may also include determining whether the similarity (e.g., cosine similarity, Euclidean distance, etc.) of the device key to the most similar locker meets or exceeds a predetermined threshold level of similarity. If the similarity metric does not meet or exceed the predetermined threshold level of similarity, the clusters (and thus also the lockers) may not adequately represent user activity. In which case, the historical device keys and the current device keys may be used for retraining the contrastive projection network of the module 106 and/or re-clustered, in a manner as described with respect to operation 204. This way, the sequence of lockers 112 can be updated and refreshed.

In some embodiments, the module 118 may, at operation 312, update the timestamp of the matching locker to reflect the current interaction time (e.g., the time of the request), making the matching locker the most recent profile in the sequence. The updated timestamp helps the matching locker remain at the forefront of the user profiles (e.g., set of lockers 112), emphasizing its relevance in future verification checks.

FIG. 4 is a sequence diagram of an example process 400 for application identifier storage. For explanatory purposes, FIG. 4 is described herein with reference to the system 100 of FIG. 1, and thus the process 400 may be computer-implemented. However, this is merely illustrative, and features of the system 100 may be performed by any other system for implementing the subject technology. Additionally, for explanatory purposes, the operations of the process 400 are described herein as occurring sequentially or linearly. However, multiple operations of the process 400 may occur in parallel. The operations of the process 400 need not be performed in the order shown, and one or more operations of the process 400 need not be performed or can be replaced by other operations.

An application identifier (also referred to as an “app ID”) may be a unique identifier that can be used to differentiate devices. An application installed on a user device (e.g., device 104) may generate a different application identifier for each device on which it is installed. Despite the possibility of manipulation of the application identifier, the application identifier can still be used to identify a user device 104, especially when paired with behavioral data together in the form of a device key.

However, limitations imposed by many device platforms (e.g., mobile operating systems) limit the ability of certain processes to obtain the application identifier. For example, an application identifier may only be obtained by the installed application, in some embodiments. Accordingly, the process 400 describes a cookie injection approach to enable the collection of the application identifier by another process on a user device (e.g., a web browser). FIG. 5, discussed after FIG. 4, will describe an example use of an application identifier stored in a cookie.

At operation 410, a platform associated with an application 402 installed on the user device 104 may receive a log in attempt. For example, user 102 may open the application on device 104 (e.g., a smartphone) and press a login link displayed on device 104.

At operation 412, application 402, recognizing that user 102 is attempting to log in, may invoke an in-app web browser 404. The in-app web browser 404 may display a login page of the platform with which the user 102 may log in to the platform. For example, the in-app web browser 404 may display a login form that includes a username field and a password field, along with a submit button. In some embodiments, the platform may be hosted by the server 408, and thus the server 408 may provide the login page.

At operation 414, the application 402 may provide the application identifier to the in-app web browser 404 for storage in a cookie of the in-app web browser 404. In some embodiments, the receipt of the application identifier by the in-app web browser 404 from the application 402 may be part of the application 402 invoking the browser 404.

At operation 416, as the user 102 may proceed to log in via the in-app web browser 404, the in-app web browser 404 may interact with the corresponding server 408 of the platform to facilitate the authentication of the user 102. For example, at operation 416, the in-app web browser 404 may generate a login request with credentials input by the user 102, and the login request may be transmitted to the server 408.

At operation 418, the server 408 may authenticate the user 102, either allowing or rejecting the request (e.g., attempted login) by the user 102. For example, at operation 418, the server 408 may compare the credentials in the login request against a database of user credentials to authenticate the user. If the server 408 can identify the credentials in the database, the server 408 may approve the login request. If not, the server 408 may deny the login request.

FIG. 5 depicts a sequence diagram of an example process 500 for application identifier retrieval and use. For explanatory purposes, FIG. 5 is described herein with reference to the system 100 of FIG. 1 and the process 400 of FIG. 4, and thus the process 500 may be computer-implemented. However, this is merely illustrative, and features of the system 100 may be performed by any other system for implementing the subject technology. Additionally, for explanatory purposes, the operations of the process 500 are described herein as occurring sequentially or linearly. However, multiple operations of the process 500 may occur in parallel. The operations of the process 500 need not be performed in the order shown, and one or more operations of the process 500 need not be performed or can be replaced by other operations.

An application 402 associated with a platform (e.g., a web application, web service, API) may be installed on the user device 104. Once an application identifier is stored (e.g., via process 400) in a cookie 406, the application identifier can be obtained by other applications, such as a web browser 502 that share the same cookie storage as the in-app web browser 404 on the user device 104. The web browser 502 may be a standalone web browser that may be independently invoked (e.g., without the application 402).

At operation 504, the user 102 may use the web browser 502 to login to the platform via a website of the platform (e.g., hosted on server 408). The website may include web content (e.g., a login page of the platform) with which the user 102 may log in to the platform. For example, web browser 502 may display login forms that include a username field and a password field, along with a submit button. It should be understood that logging in to the platform is merely one example of an interaction with a server 408 and that other interactions utilizing device verification techniques described herein are contemplated. It should also be understood that the server 408 may represent server 122 and may be embodied by computing system 700.

At operation 506, when web browser 502 renders the web content, the web browser 502 may obtain (e.g., retrieve) the application identifier from the cookie 406. The in-app web browser 404 within an application 402 may use a system-provided web engine (e.g., WebView or WKWebView) to display web content within the application 402. The system-provided web engine may share the same cookie storage as the web browser 502. This means that cookies set by the in-app web browser 404 may be accessed by the web browser 502, and vice versa. The web browser 502 may then obtain the application identifier from information included in the cookie 406.

At operation 508, the web browser 502 may insert the application identifier into the web content. Inserting the application identifier into the web content may include inserting the application identifier into a hidden field of the web content (e.g., the login form). This way, the application identifier may be submitted to server 408 along with the login information input by user 102 when the user submits the login form. Alternatively, inserting the application identifier into the web content may include inserting the application identifier into the login request generated by the web browser 502 in response to the user submitting the login form.

The web browser 502 may also insert the behavioral information into the web content. The web browser 502 may include one or more scripts for obtaining behavior information from the user interface provided by the web browser 502 and/or from the device on which the web browser 502 is running. As described above, behavior information may include attributes (e.g., metadata) about the user device 104, user interaction with the web browser 502, user interaction with the platform (e.g., via the server 408), and/or the like. Like the application identifier, the web browser 502 may insert the behavioral information into one or more hidden fields of the web content (e.g., the login form) and/or into the login request generated by the web browser 502 in response to the user submitting the login form.

In some embodiments, the web browser 502 may vectorize the application identifier and/or the behavioral data before inserting them into the web content. The web content rendered by the web browser 502 may include a script (e.g., provided by the server 408) that, when executed by the web browser 502, causes the web browser 502 to transform the application identifier and/or the behavioral data into a structured, numerical format (e.g., vectors) that the server 408 can more easily process, which also improves security by minimizing the amount of raw data transmitted to the server 408. For example, the script may cause the web browser 502 to convert the application identifier into a vector embedding with a FastText algorithm.

At operation 510, as the user 102 logs in via the web browser 502 application, the web browser 502 may interact with the corresponding server 408 of the platform to facilitate authentication of the user 102 and/or verification of the user device 104. An interaction with the server 408 may include the web browser 502 sending to the server 408 the login request generated in operation 508, which may include credentials of the user 102, the application identifier, and/or behavior information.

At operation 512, the server 408 may authenticate the user 102, either allowing or rejecting the request (e.g., attempted login) by the user 102. In addition, the server 408 may perform device verification, in a manner described above with respect to process 300. In short, the server 408 may receive the application identifier and key embedding (e.g., metadata and behavioral data), generate a device key based on the application identifier and key embedding, and determine whether the device lockers (e.g., lockers associated with the account of the user) include a device locker that matches the device key.

If a match is found, the device may be considered verified, and the server 408 may proceed to authenticate the user. If a match is not found, the server 408 may reject the request (e.g., attempted login). In some embodiments, the server 408 may request further validation from the user 102. For example, the server 408 may email the user 102 a multifactor authentication code, which the user 102 may provide to the server 408 via the web browser 502. If the device key is unmatched but verified (e.g., via multifactor authentication), the device key may be added to the set of historical device keys associated with the user 102 and the device lockers may be updated, as described above with respect to operation 312.

At operation 514, the web browser 502 may present an indication to the user 102 that the login is complete. For example, if the login was successful, the web browser 502 may display a homepage of the account of the user 102; if the login was unsuccessful, the web browser 502 may display an error message indicating that the user 102 could not be logged in.

FIG. 6 is a block diagram of an example process 600 for key-locker matching by sequence labeling. Not all of the depicted components may be used in all embodiments, and one or more embodiments may include additional, fewer, or different components than those shown in the figure. Variations in the arrangement and type of components may be made without departing from the spirit or scope of the claims as set forth herein.

The process 600 may begin with a device key 603 (e.g., generated by device key generation module 108) and a set of device lockers 112 as inputs to a sequence labeler 614 (e.g., in a key-locker matching module 110). The device key 603 and set of device lockers 112 may be stored as embeddings ready for input to the sequence labeler 614. The sequence labeler 614 includes a pipeline of machine learning models used for generating a label sequence 616 (label 616a, 616b, . . . , 616n) corresponding to the set of device lockers 112. The set of device lockers 112 may be arranged (e.g., chronologically) for sequence labeling to capture the evolution of a user's device behavior and interaction patterns over time.

In the sequence labeler 614, an embedding model 608 may generate a context-aware embedding for each locker with the device key 603 using an embedding technique such as BERT. The contextual embeddings may capture information from left and right contexts in the sequence of lockers (e.g., previous and subsequent lockers relative to each locker). This context may reflect differences between consecutive lockers.

In the sequence labeler 614, a hidden state model 610 may process the set of embeddings in both forward and backward directions, capturing sequential dependencies between lockers and recognizing patterns over time, using techniques such as BiLSTM. This helps the model 610 understand the flow of behaviors and identify any continuity or inconsistencies between the device key and past lockers. The output of the model 610 may be a set of hidden states, which incorporates information from both past and future tokens. For example, each locker lₜ in a sequence of lockers l=(l₁, l₂, . . . , l_{T}) may correspond to a context-aware embedding hₜ=BERT(lₜ, k), where k is the device key. Each embedding may be processed in a forward direction \vec{hₜ}=LSTM_{fwd}(hₜ, \vec{hₜ₋₁}) and a backward direction [symbol] =LSTM_{fwd}(hₜ, [symbol] ). The output of model 610 is concatenated hidden states zₜ=└\vec{hₜ}; [symbol] ┘, which incorporates both past and future tokens.

In the sequence labeler 614, the transition probabilities model 612 (e.g., HMM) may be used to calculate the transition probability between each state and predict the most likely sequence of labels y=(y₁, y₂, . . . , y_{T}) (e.g., match or not match) by considering both the current locker's state and the preceding labels in the sequence. The transition probabilities describe the likelihood of moving from one label (state) to another between adjacent lockers. For example, the transition probability P(yₜ, yₜ₋₁) may indicate how likely it is for a “match” to follow another “match” or for a “not match” to follow a “match.”

This probability-based approach may allow the model 612 to factor in the likelihood of transitions, such as moving from a matched locker to a non-matched one, depending on historical usage patterns. The model 612 may use the output of the model 610 to compute the probabilities of the matching status for each locker y=(y₁, y₂, . . . , y_{T}) by

$$P ( y \vert z ) = {\prod }_{t = 1}^{T} P ( {y}_{t} \vert {y}_{t - 1} , {z}_{t} ) .$$

For each matching status yₜ, the model 612 may consider the previous matching status y_{t_1} and the current key-locker matching hidden state zₜ.

The label sequence 616 (e.g., “match” or “not match” for each locker 112) may be decoded from the set of hidden states generated by the model 610 (e.g., BiLSTM) and the transition probabilities between labels in the transition probabilities model 612. The transition probabilities model 612 may decode the label sequence using, for example, a Viterbi algorithm, which may find the most probable sequence of labels by maximizing the overall probability of the sequence given the hidden states and transition probabilities.

After processing the sequence of lockers 112, the sequence labeler 614 may produce an output label sequence 616 that indicates whether each locker 112 is a “match” or “not match” in relation to the device key 603. The label sequence 616 may provide a comprehensive view of the compatibility of the device key 603 with the user's historical profiles (the lockers 112), revealing how closely the current device state (device key 603) aligns with historical patterns. The label sequence 616 may also serve as the basis for determining if any of the lockers 112 indeed match the device key 603, highlighting where the current device interaction fits within the user's established history.

FIG. 7 is a block diagram of an example computing system 700. A computing system 700 may be a desktop computer, laptop, smartphone, tablet, or any other electronic device having the ability to execute instructions, such as those stored within a non-transitory computer-readable medium. Furthermore, while described and illustrated in the context of a single computing system 700, those skilled in the art will also appreciate that the various tasks described hereinafter may be practiced in a distributed environment having multiple computing systems 700 linked via a local- or wide-area network in which the executable instructions may be associated with and/or executed by one or more of multiple computing systems 700.

In its most basic configuration, the computing system 700 may include at least one processing unit 702 and at least one memory 704, which may be linked via a bus 706. Depending on the exact configuration and type of computing system environment, memory 704 may be volatile (such as RAM 710), non-volatile (such as ROM 708, flash memory, etc.) or some combination of the two.

Computing system 700 may have additional features and/or functionality. For example, computing system 700 may also include additional storage (removable and/or non-removable) including, but not limited to, magnetic or optical disks, tape drives and/or flash drives. Such additional memory devices may be made accessible to the computing system 700 by means of, for example, a hard disk drive interface 712, a magnetic disk drive interface 714, and/or an optical disk drive interface 716. As will be understood, these devices, which may be linked to the system bus 706, respectively, allow for reading from and writing to a hard drive 718, reading from or writing to a removable magnetic disk 720, and/or for reading from or writing to a removable optical disk 722, such as a CD/DVD ROM or other optical media. The drive interfaces and their associated computer-readable media may allow for the non-volatile storage of computer-readable instructions, data structures, program modules and other data for the computing system 700. Those skilled in the art will further appreciate that other types of computer-readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer-readable (e.g., computer-implemented) instructions, data structures, program modules or other data. Any such computer storage media may be part of computing system 700.

A number of program modules may be stored in one or more of the memory/media devices. For example, a basic input/output system (BIOS 724), containing the basic routines that help to transfer information between elements within the computing system 700, such as during start-up, may be stored in ROM 708. Similarly, RAM 710, hard drive 718, and/or peripheral memory devices may be used to store computer-executable instructions comprising an operating system 726, one or more applications programs 728, other program modules 730, and/or program data 732. Still further, computer-executable instructions may be downloaded to the computing system 700 as needed, for example, via a network connection. The applications programs 728 may include, for example, modules 106, 110, 106, 118, 120.

An end-user may enter commands and information into the computing system 700 through input devices such as a keyboard 734 and/or a pointing device 736. While not illustrated, other input devices may include a microphone, a joystick, a game pad, a scanner, etc. These and other input devices would typically be connected to the processing unit 702 by means of a peripheral interface 738 which, in turn, would be coupled to bus 706. Input devices may be directly or indirectly connected to processing unit 702 via interfaces such as, for example, a parallel port, game port, firewire, or a universal serial bus (USB). To view information from the computing system 700, a monitor 740 or other type of display device may also be connected to bus 706 via an interface, such as via video adapter 742. In addition to the monitor 740, the computing system 700 may also include other peripheral output devices, not shown, such as speakers and printers.

The computing system 700 may also utilize logical connections to one or more computing system environments. Communications between the computing system 700 and the remote computing system environment may be exchanged via a further processing device, such as a network router 741, that is responsible for network routing. Communications with the network router 741 may be performed via a network interface component 744. Thus, within such a networked environment, e.g., the Internet, wide area network (WAN), local area network (LAN), or other like type of wired or wireless network, it will be appreciated that program modules depicted relative to the computing system 700, or portions thereof, may be stored in the memory storage device(s) of the computing system 700.

The computing system 700 may also include localization hardware 746 for determining a location of the computing system 700. In embodiments, the localization hardware 746 may include, for example, a GPS antenna, an RFID chip or reader, a Wi-Fi antenna, or other computing hardware that may be used to capture or transmit signals that may be used to determine the location of the computing system 700.

While this disclosure has described certain embodiments, it is understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, the subject technology is not limited to the specific details set forth herein and can be practiced using one or more other embodiments. In other instances, well known methods, procedures, components, and circuits have not been described in detail as not to unnecessarily obscure various aspects of the present disclosure. Additionally, in one or more embodiments, structures and components are shown in block diagram form to avoid obscuring the concepts of the subject technology.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It is understood, however, that these terms are to be interpreted as referencing physical manipulations and quantities and are merely convenient labels that should be interpreted further in view of terms commonly used in the art.

Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of any of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Headings and subheadings, if any, are used for convenience only and do not limit the subject disclosure.

What is claimed is:

1. A computer-implemented method comprising:
partitioning, by a first computing system, a set of historical device keys into a set of clusters;
embedding, by the first computing system, the set of clusters to generate a set of device lockers;
receiving, by the first computing system and from a second computing system, a request including an application identifier and metadata, wherein the application identifier corresponds to an application installed on the second computing system and the metadata corresponds to the second computing system;
combining, by the first computing system, the application identifier and the metadata to generate a device key;
determining, by the first computing system and with one or more machine learning models trained for sequence labeling, that the set of device lockers includes a device locker that matches the device key; and
in response to determining that the set of device lockers includes the device locker that matches the device key, adding the device key to a cluster of the set of clusters corresponding to the device locker.

2. The computer-implemented method of claim 1, further comprising, in response to determining that the set of device lockers lacks a device locker that matches the device key, blocking the request from the second computing system.

3. The computer-implemented method of claim 1, wherein embedding the set of clusters comprises, for each cluster of the set of clusters:
determining a centroid of a respective cluster; and
generating an embedding of the centroid to represent the respective cluster as a respective device locker.

4. The computer-implemented method of claim 1, wherein, before partitioning, each respective historical device key of the set of historical device keys is weighted according to an age of the respective historical device key such that the set of clusters is time weighted.

5. The computer-implemented method of claim 1, wherein the application identifier is obtained from a web browser cookie.

6. The computer-implemented method of claim 1, wherein the metadata includes a representation of any one or more of attributes of the second computing system, attributes of a web browser of the second computing system, or user interactions with the second computing system in sending the request.

7. The computer-implemented method of claim 1, wherein combining the application identifier and the metadata to generate the device key comprises:
converting the application identifier into a first embedding and the metadata into a second embedding; and
combining the first embedding and the second embedding to form the device key.

8. The computer-implemented method of claim 1, further comprising, before determining whether the set of device lockers includes the device locker that matches the device key:
converting, with a projection model, the device key into a representation space, the representation space shared with the set of device lockers.

9. The computer-implemented method of claim 1, wherein determining whether the set of device lockers includes the device locker that matches the device key comprises:
generating, with the one or more machine learning models, a sequence of labels based at least in part on the device key and a set of transition probabilities between each device locker, wherein each label of the sequence of labels indicates whether a corresponding device locker matches the device key; and
selecting the device locker that corresponds to a label of the sequence of labels, the label indicating that the device locker matches the device key.

10. The computer-implemented method of claim 9, wherein generating the sequence of labels corresponding to the set of device lockers comprises:
arranging the set of device lockers chronologically, wherein the chronological set of device lockers includes a set of past device lockers and a set of future device lockers for each device locker;
generating, by a first machine learning model, a set of contextual embeddings based on the chronological set of device lockers and the device key;
generating, by a second machine learning model different from the first machine learning model, a set of hidden states based on the set of contextual embeddings, wherein each hidden state is generated for a respective set of past device lockers and a respective set of future lockers of each device locker;
generating, by a third machine learning model different from the first machine learning model and the second machine learning model, the set of transition probabilities between each device locker of the chronological set of device lockers based on the set of hidden states; and
decoding the sequence of labels based on the set of hidden states and the set of transition probabilities for each device locker.

11. The computer-implemented method of claim 1, wherein adding the device key to the cluster of the set of clusters comprises:
adding the device key to the set of historical device keys; and
partitioning the set of historical device keys into an updated set of clusters, the updated set of clusters corresponding to an updated set of device lockers.

12. A computing system comprising:
a processor; and
a non-transitory computer-readable medium storing instructions that, when executed by the processor, cause the computing system to perform operations comprising:
partitioning, by the computing system, a set of historical device keys into a set of clusters, the set of clusters representing a set of device lockers;
receiving, by the computing system and from another computing system, a request;
generating, by the computing system, a device key based on the request;
determining, by the computing system and with one or more machine learning models trained for sequence labeling, that the set of device lockers includes a device locker that matches the device key; and
in response to determining that the set of device lockers includes the device locker that matches the device key, adding the device key to the set of historical device keys.

13. The computing system of claim 12, wherein each device locker in the set of device lockers includes an embedding of a centroid of a respective corresponding cluster.

14. The computing system of claim 13, wherein, before partitioning, time-weighting the set of clusters based on the set of historical device keys.

15. The computing system of claim 13, wherein the request is received from a web browser of the other computing system, the request includes an application identifier and metadata.

16. The computing system of claim 15, wherein the metadata includes a representation of any one or more of attributes of the other computing system, attributes of a web browser of the other computing system, or user interactions with the other computing system in sending the request.

17. The computing system of claim 15, wherein generating the device key comprises:
converting the application identifier into a first embedding and the metadata into a second embedding; and
combining the first embedding and the second embedding to form the device key.

18. The computing system of claim 13, wherein determining whether the set of device lockers includes the device locker that matches the device key comprises:
sequence labeling, with the one or more machine learning models, the set of device lockers to generate a set of labels, wherein the set of labels is generated as a function of the device key, a set of hidden states of each device locker, and a set of transition probabilities between each device locker, and wherein each label of the set of labels indicates whether a device locker matches the device key; and
selecting the device locker that corresponds to a label of the set of labels, the label indicating that the device locker matches the device key.

19. The computing system of claim 13, further comprises, after adding the device key to the set of historical device keys:
partitioning the set of historical device keys into an updated set of clusters, the updated set of clusters corresponding to an updated set of device lockers.

20. A non-transitory computer-readable medium storing instructions that, when executed by a processor of a computing system, cause the computing system to perform operations comprising:
receiving, by the computing system and from another computing system, a request;
generating, by the computing system, a device key based on the request;
determining, by the computing system and with one or more machine learning models trained for sequence labeling, that a set of device lockers includes a device locker that matches the device key, wherein each device locker of the set of device lockers corresponds to a respective embedded cluster of a clustered set of historical device keys; and
in response to determining that the set of device lockers includes the device locker that matches the device key, adding the device key to the clustered set of historical device keys.
